(19) United States
(12) Patent Application Publication
(10) Pub. No.: US 2023/0206592 A1
(43) Pub. Date: Jun. 29, 2023

(54) METHOD AND ELECTRONIC DEVICE FOR DIGITAL IMAGE ENHANCEMENT ON DISPLAY

(71) Applicant: SAMSUNG ELECTRONICS CO., LTD., Suwon-si (KR)

(72) Inventors: Genemala HAOBIJAM, Imphal (IN); Maninder SINGH, Ghaziabad (IN); Manjunath Vinay ARGEKAR, Karwar (IN)

(73) Assignee: SAMSUNG ELECTRONICS CO., LTD., Suwons-i (KR)

(21) Appl. No.: 18/117,890

(22) Filed: Mar. 6, 2023

Related U.S. Application Data
(63) Continuation of application No. PCT/KR22/19205, filed on Nov. 30, 2022.

(30) Foreign Application Priority Data
Nov. 30, 2021 (IN) 202141055356

(51) Int. Cl. G06V 10/56; G06T 17/00; G06T 7/90; G06V 10/60; G06V 10/75; G06V 10/74; G09G 3/22

(52) U.S. Cl. CPC G06V 10/56; G06T 17/00; G06T 7/90; G06V 10/60; G06V 10/751; G06V 10/761; G09G 3/22; G09G 2320/0666; G09G 2360/144; G06T 2207/10024

(57) ABSTRACT

A method for digital image enhancement on a display of an electronic device includes receiving, by the electronic device, an original image, sensing, by the electronic device, an ambient light, generating, by the electronic device, a virtual content appearance of the original image based on the ambient light and characteristics of the display of the electronic device, determining, by the electronic device, a compensating color tone for the original image based on the virtual content appearance, modifying, by the electronic device, the original image based on the compensating color tone for the original image, and displaying, by the electronic device, the modified original image for a current viewing condition.

### CROSS-REFERENCE TO RELATED APPLICATION(S)

This application is a bypass continuation of International Application No. PCT/KR2022/019205, filed on Nov. 30, 2022, in the Korean Intellectual Property Receiving Office, which is based on and claims priority to Indian Patent Application No. 202141055356, filed on Nov. 30, 2021, in the Indian Patent Office, the disclosures of which are incorporated herein by reference in their entireties.

### BACKGROUND

### 1. Field

The disclosure relates to image processing and more specifically related to a method and an electronic device for digital image enhancement on a display in ambient light conditions.

### 2. Description of Related Art

In general, with the advancement in smart lighting systems, ambient viewing conditions of an electronic display device changes throughout a day. Use of pleasant color is highly variable with respect to each user. Perception of viewed colors on the electronic display device also changes with intensity and color temperature of an ambient light source such as for example but not limited to light emitting diode (LED), fluorescent light source, incandescent light source, sunlight, etc.

FIG. 1A is a diagram of different lighting conditions and corresponding represented color temperature, according to related art. Further, a display panel on an electronic device is also a light source which has own luminance and color temperature. The ambient light color temperature causes an imbalance in color of content displayed on a screen of the electronic device. As a result, the color of the content viewed on the display of the electronic device becomes inconsistent and may not be accurate in different viewing condition. Further, the perception of the viewed colors depends on light reflected from a surface of the screen of the electronic device and a light emitted by the display.

FIG. 1B is a diagram illustrating an original image displayed on screen of electronic device in current viewing condition, according to related art. The color appears different from original color of the content displayed, as illustrated in FIG. 1B. Therefore, it is important to find effect of multiple factors before displaying the image to keep perceived color constant as that of the original image under any ambient light condition.

Thus, it is desired to address the above mentioned disadvantages or other shortcomings or at least provide a useful alternative.

### SUMMARY

Provided are a method and an electronic device for digital image enhancement on a display in ambient light conditions. The provided method and device may ensure that when an image is displayed in current viewing conditions, the image appears the same as an original image with the impact of the ambient light conditions nullified using artificial intelligence (AI) techniques. Therefore, the provided method and device modifies the image to suit the current viewing conditions and thereby enhances user experience.

Additional aspects will be set forth in part in the description which follows and, in part, will be apparent from the description, or may be learned by practice of the presented embodiments.

According to an aspect of the disclosure, a method for digital image enhancement on a display of an electronic device may include receiving, by the electronic device, an original image, sensing, by the electronic device, an ambient light, generating, by the electronic device, a virtual content appearance of the original image based on the ambient light and characteristics of the display of the electronic device, determining, by the electronic device, a compensating color tone for the original image based on the virtual content appearance, modifying, by the electronic device, the original image based on the compensating color tone for the original image, and displaying, by the electronic device, the modified original image for a current viewing condition.

Generating the virtual content appearance of the original image may include determining, by the electronic device, an illuminance factor of viewing conditions based on content of the original image, the ambient light and the characteristics of the display of the electronic device, estimating, by the electronic device, an appearance of a color tone of the content in the original image based on the illuminance factor of the viewing conditions, and generating, by the electronic device, the virtual content appearance of the original image based on the estimated appearance of the color tone of the content in the original image using a first AI model.

Determining, by the electronic device, the illuminance factor of the viewing conditions may include determining, by the electronic device, a tri-stimulus value of a virtual illuminant of the viewing conditions based on the original image, ambient light data and the characteristics of the display of the electronic device, determining, by the electronic device, chromaticity co-ordinates for the virtual illuminant of the viewing conditions based on the determined tri-stimulus value, determining, by the electronic device, a luminance of the virtual illuminant based on a coordinate of the determined tri-stimulus value, and determining, by the electronic device, the illuminance factor of the viewing conditions based on the tri-stimulus value and the chromaticity co-ordinates for the virtual illuminant of the viewing conditions.

Generating, by the electronic device, the virtual content appearance of the original image may include concatenating, by the electronic device, the illuminance factor of the viewing conditions and the original image, determining, by the electronic device, a first intermediate image based on the concatenated illuminance factor and the original image as inputs to a generative adversarial network (GAN) model, determining, by the electronic device, a difference measure between the first intermediate image and training images, where the training images comprise a plurality of versions of the original image captured using a plurality of expected ambient light conditions, and determining, by the electronic device, the virtual content appearance of the original image by compensating for the difference measure in the first intermediate image.

The GAN model may generate an image transformation matrix based on the training images, and the GAN model may determine the first intermediate image based on the image transformation matrix.

Determining, by the electronic device, the compensating color tone for the original image may include performing, by the electronic device, a pixel difference calculation of a color tone of the original image and a color tone of the virtual content appearance, generating, by the electronic device, a color compensation matrix for each of a red (R) channel, a green (G) channel, and a blue (B) channel based on the pixel difference calculation of the color tone of the original image and the color tone of the virtual content appearance, and determining, by the electronic device, the compensating color tone for the original image based on the color compensation matrix. The compensating color tone for the original image may allow a user to view the original image in an original color tone in the current viewing condition.

Modifying, by the electronic device, the original image may include determining, by the electronic device, a plurality of pixels in the original image that are impacted by the ambient light based on the virtual content appearance, applying, by the electronic device, the compensating color tone for the original image to each of the plurality of pixels in the original image, and modifying, by the electronic device, a color tone of content in the original image based on the compensating color tone for the original image.

The method may include obtaining, by the electronic device, an illuminance factor of viewing conditions of the original image, generating, by the electronic device, a color compensated original image for the current viewing condition using a second AI model, and displaying, by the electronic device, the color compensated original image for the current viewing condition.

The second AI model may be trained based on a plurality of modified original images.

Generating, by the electronic device, the color compensated original image may include concatenating, by the electronic device, the illuminance factor of the viewing conditions and the original image, determining, by the electronic device, a second intermediate image based the concatenated illuminance factor and the original image as inputs to a GAN model, determining, by the electronic device, a difference measure between the second intermediate image and training images, wherein the training images comprise a plurality of versions of the plurality of modified original images, and generating, by the electronic device, the color compensated original image for the current viewing condition using the second AI model.

The characteristics of the display of the electronic device may include at least one of a peak brightness of the display of the electronic device, a color temperature of the display, a color temperature of the original image, a luminance of the original image, and a color space of the original image.

The ambient light may include a luminance of the ambient light and a correlated color temperature of the ambient light.

The virtual content appearance of the original image may include a presentation of contents of the original image in the current viewing condition of the ambient light

According to an aspect of the disclosure, an electronic device for digital image enhancement on a display of the electronic device may include a memory and an image enhancement controller coupled to the memory and configured to receive an original image, sense an ambient light, generate a virtual content appearance of the original image based on the ambient light and characteristics of the display of the electronic device, determine a compensating color tone for the original image based on the virtual content appearance, modify the original image based on the compensating color tone for the original image, and display the modified original image for a current viewing condition.

The image enhancement controller may be configured to generate the virtual content appearance of the original image by determining an illuminance factor of viewing conditions based on content of the original image, the ambient light and the characteristics of the display of the electronic device, estimating an appearance of a color tone of the content in the original image based on the illuminance factor of the viewing conditions, and generating the virtual content appearance of the original image based on the estimated appearance of a color tone of the content in the original image using a first AI model.

The image enhancement controller may be configured to determine the illuminance factor of the viewing conditions by determining a tri-stimulus value of a virtual illuminant of the viewing conditions based on the original image, ambient light data and the characteristics of the display of the electronic device, determining a chromaticity co-ordinates for the virtual illuminant of the viewing conditions based on the determined tri-stimulus value, determining a luminance of the virtual illuminant based on a coordinate of the determined tri-stimulus value, and determining the illuminance factor of the viewing conditions based on the tri-stimulus value and the chromaticity co-ordinates for the virtual illuminant of the viewing conditions.

The image enhancement controller may be configured to generate the virtual content appearance of the original image by concatenating the illuminance factor of the viewing conditions and the original image, determining a first intermediate image based on the concatenated illuminance factor and the original image as inputs to a GAN model, determining a difference measure between the first intermediate image and training images, where the training images comprise a plurality of versions of the original image captured using a plurality of expected ambient light conditions, and determining the virtual content appearance of the original image by compensating for the difference measure in the first intermediate image.

The GAN model may generate an image transformation matrix based on the training images, and may determine the first intermediate image based on the image transformation matrix.

The image enhancement controller may be configured to determine the compensating color tone for the original image by performing a pixel difference calculation of a color tone of the original image and a color tone of the virtual content appearance, generating a color compensation matrix for each of a red (R) channel, a green (G) channel, and a blue (B) channel based on the pixel difference calculation of the color tone of the original image and the color tone of the virtual content appearance, and determining the compensating color tone for the original image based on the color compensation matrix. The compensating color tone for the original image may allow a user to view the original image in an original color tone in the current viewing condition.

The image enhancement controller may be configured to modify the original image by determining a plurality of pixels in the original image that are impacted by the ambient light based on the virtual content appearance, applying the compensating color tone for the original image to each of the plurality of pixels in the original image, and modifying a color tone of content in the original image based on the compensating color tone for the original image.

The image enhancement controller may be further configured to obtain an illuminance factor of viewing conditions of the original image, generate a color compensated original image for the current viewing condition using a second AI model, and display the color compensated original image for the current viewing condition.

The second AI model may be trained based on a plurality of modified original images.

The image enhancement controller may be configured to generate the color compensated original image by concatenating the illuminance factor of the viewing conditions and the original image, determining a second intermediate image using the concatenated illuminance factor and the original image as inputs to a GAN model, determining a difference measure between the second intermediate image and training images, where the training images are a plurality of versions of the plurality of modified original images, and generate the color compensated original image for the current viewing condition using the second AI model.

The characteristics of the display of the electronic device may include at least one of a peak brightness of the display of the electronic device, a color temperature of the display, a color temperature of the original image, a luminance of the original image, and a color space of the original image.

The ambient light may include a luminance of the ambient light and a correlated color temperature of the ambient light.

The virtual content appearance of the original image may include a presentation of contents of the original image in the current viewing condition of the ambient light.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram of different lighting conditions and corresponding represented color temperature, according to related art;

FIG. 1B is a diagram illustrating an original image displayed in current viewing condition, according to related art;

FIG. 1C is a diagram illustrating digital image enhancement in the current viewing condition, according to an embodiment;

FIG. 2 is a block diagram of an electronic device for the digital image enhancement on a display in the current viewing condition, according to an embodiment;

FIG. 3A is a flow diagram illustrating a method for the digital image enhancement on the display of the electronic device, according to an embodiment;

FIG. 3B is a flow diagram illustrating a method for the digital image enhancement on the display of the electronic device, according to an embodiment;

FIG. 4A is a diagram of a process flow for the digital image enhancement on the display of the electronic device, according to an embodiment;

FIG. 4B is a block diagram for the digital image enhancement on the display of the electronic device, according to an embodiment;

FIG. 5A is a diagram of a process flow for the digital image enhancement on the display of the electronic device, according to an embodiment;

FIG. 5B is a block diagram for the digital image enhancement on the display of the electronic device, according to an embodiment;

FIG. 6 is a diagram of a virtual content management controller configured to generate a illuminance factor of a viewing condition, according to an embodiment;

FIG. 7A is a diagram of various components of a first artificial intelligence (AI) model for determining a virtual content appearance of an original image, according to an embodiment;

FIG. 7B is a diagram of various layers of a generator network of the first AI model, according to an embodiment;

FIG. 7C is a diagram of target image generation process in the first AI model, according to an embodiment;

FIG. 7D is a diagram of various layers of a discriminator network of the first AI model, according to an embodiment;

FIG. 8A is a diagram of various components of a second AI model for obtaining a color compensated original image for the current viewing condition, according to an embodiment;

FIG. 8B is a diagram of a target image generation process in the second AI model, according to an embodiment;

FIG. 9 is a diagram of a color compensation controller in the first process flow for determining the virtual content appearance of the original image, according to an embodiment;

FIG. 10A is a diagram illustrating the generation of an adapted image for the current viewing condition by the color compensation controller in a first process flow, according to an embodiment as disclosed herein;

FIG. 10B is a diagram illustrating R, G, B components of the original image and the adapted image, according to an embodiment;

FIG. 10C is a diagram illustrating various versions of the original image during the digital image enhancement, according to an embodiment;

FIG. 10D is a diagram illustrating perception of a color in various viewing conditions, according to an embodiment;

FIG. 11A is a diagram illustrating a scenario of an image perceived in different viewing conditions, according to related art;

FIG. 11B is a diagram illustrating a scenario of the image perceived in different viewing conditions, according to an embodiment; and

FIG. 12 is a diagram illustrating a scenario of an image of a product perceived during online shopping, according to an embodiment.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc., may be used herein to describe various elements, these elements should not be limited by these terms. These terms are generally only used to distinguish one element from another.

Accordingly, the embodiment herein is to provide a method for digital image enhancement on a display of an electronic device. The method includes receiving, by the electronic device, an original image and sensing, by the electronic device, an ambient light. The method also includes generating, by the electronic device, a virtual content appearance of the original image based on the ambient light and characteristics of display of the electronic device and determining, by the electronic device, a compensating color tone for the original image using the virtual content appearance. Further, the method also includes modifying, by the electronic device, the original image using the compensating color tone for the original image; and displaying, by the electronic device, the modified original image for current viewing condition.

Accordingly, the embodiments herein provide the electronic device for digital image enhancement on a display. The electronic device includes a memory, a processor, a communicator, a plurality of image sensors and an image enhancement controller. The image enhancement controller is configured to receive an original image and sense an ambient light. The image enhancement controller is configured to generate a virtual content appearance of the original image based on the ambient light and characteristics of display of the electronic device and determine a compensating color tone for the original image using the virtual content appearance. Further, the image enhancement controller is configured to modify the original image using the compensating color tone for the original image; and display the modified original image for current viewing condition.

The conventional methods and systems, for chromatic adaptation are not able to reproduce color appearance of images for self-luminous displays under different lighting and viewing conditions.

Conventionally, the color appearance is determined only under standard illuminant and for scenarios in which only a change in state of chromatic adaptation is present (i.e., change in white point only).

Therefore, with respect to the performance of the self-luminous displays, the conventional color appearance model is of little utility as actual viewing conditions are not the same as those used in the model calculations. Further, the viewing medium (self-luminous) significantly affects a degree of chromatic adaptation which is generally not accounted for due to complexity. With advancement in illumination related technology, non-standard light sources and color-tunable light-emitting diode (LED) lighting are widely used. As a result, color constancy becomes highly important.

In the conventional methods and systems, the electronic device dynamically adjusts the brightness of the display to match surrounding environment, so that the display resembles a physical photo. However, the color accuracy of a scene is not preserved.

In the conventional methods and systems, a true tone viewing mode is provided which allows the electronic device to automatically change a white point and color balance of the display based on real-time measurements of ambient light reading. The white point of the display changes from 6500 K standard. As a result, absolute color accuracy throughout entire color gamut is drastically affected and eventually reduced as there is mechanism by which the color accuracy of the scene is not preserved.

Unlike conventional methods and systems, some embodiments disclosed herein may use ambient light sensor to measure brightness or illuminance and correlated color temperature (CCT) of the ambient light incident on the surface of the display of the electronic device. Further, some embodiments may include determining a user preference history of white point in several viewing condition space like user home, user office, daylight, morning, evening, etc.

Unlike conventional methods and systems, some embodiments may analyse the viewing condition based on various factors such as peak brightness of the viewing medium (e.g., liquid crystal display (LCD), organic LED (OLED), etc.) as per the brightness settings of the electronic device, the color temperature of the viewing medium as per the screen mode settings of the electronic device, the color temperature, luminance, color space of input image to be displayed, etc. Further, the method may include dynamically adjusting the required white point to the user's preferred white point for the current ambient viewing condition.

Unlike conventional methods and systems, some embodiments may include determining virtual illuminance parameters like CCT and luminance of the viewing medium of the electronic device and estimating the appearance of the image in the ambient condition using an artificial intelligence (AI) model. The AI model is used to predict how the color will appear to be shifted due to the ambient lighting, device settings, etc., which has a different color temperature as compared to the image. All colors of a color space may be modelled to find out how it will be appear in a new virtual illuminant with different color temperature and luminance. Then the method includes generating a color compensation primary red (R), green (G), blue (B) (RGB) tone curves based on the comparison of the original image and the estimated color appearance, and then generate chromatic adapted image of the original image which when viewed in the ambient light condition will be perceived as true accurate color of the original image and hence perceived constant color.

New parameters may include chroma (CCT) of ambient light, which measures the chromatic information of ambient light, used to calculate the color distortion on the displayed image; source image data, which may be used to determine the amount of local chromatic adaptation required based on the content of the image; users white point preference, which may adjust for the user's color perception, as it varies between individuals, such that accuracy may be personalized for each user; and display characteristics (e.g., brightness setting, CCT, luminance, etc.), where the panel characteristics for luminance scaling and chroma of hardware (HW) panels affects the image being produced, such that chromatic correction may be fine-tined using these parameters.

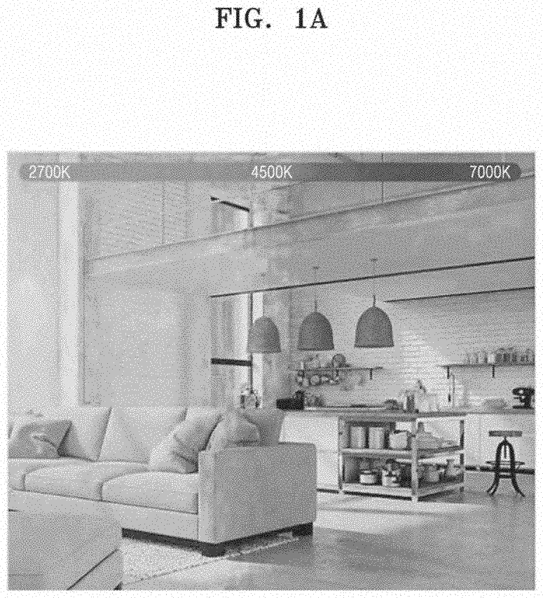

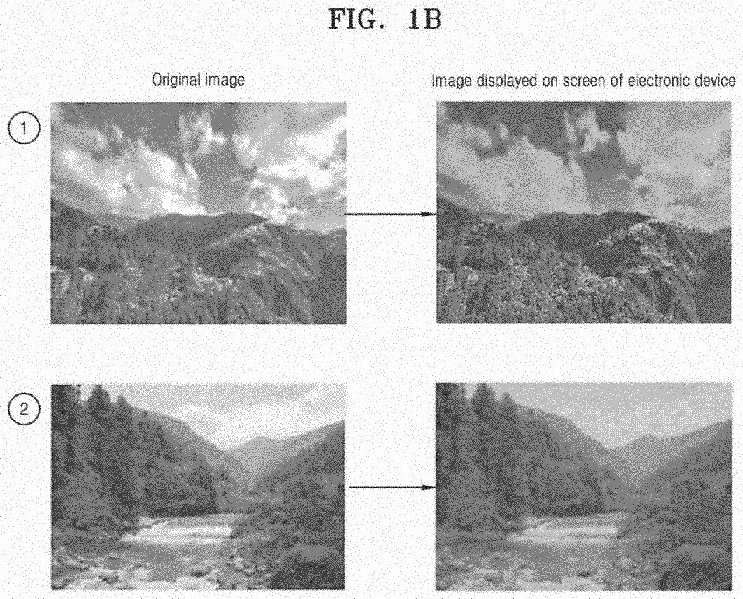

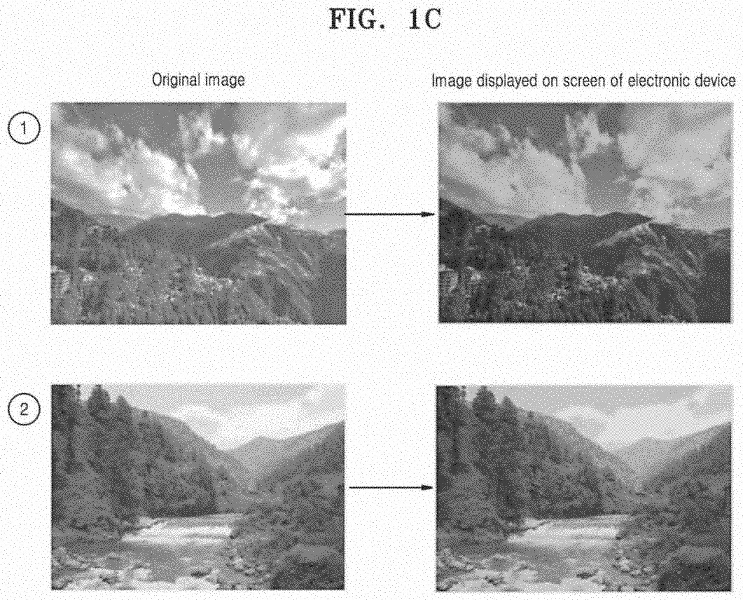

Referring now to the drawings and more particularly to FIGS. 1C through 12, where similar reference characters denote corresponding features consistently throughout the figures, there are shown preferred embodiments.

FIG. 1C is a diagram illustrating digital image enhancement in the current viewing condition, according to an embodiment.

Referring to the FIG. 1C in conjunction with the FIG. 1B, unlike to the conventional methods and systems, in the method disclosed herein, the ambient light conditions, characteristics of a display of the electronic device are taken into consideration to modify the original image. As a result, the modified original image displayed on screen of electronic device is suitable to the viewing condition and appears same as the original image without any change in the color. Therefore, the method disclosed herein ensures that the viewing condition does not result in any change in the color perception of the image when viewed by a user.

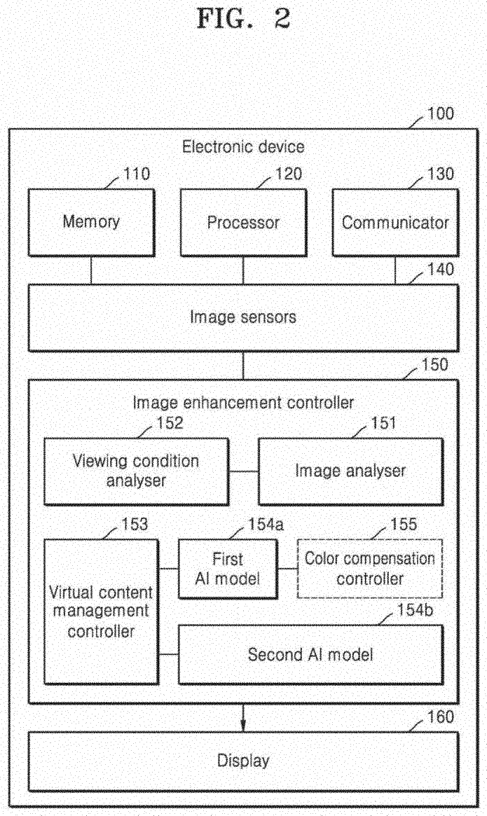

FIG. 2 is a block diagram of an electronic device 100 for digital image enhancement on a display 160 in current viewing condition, according to an embodiment. The electronic device 100 can be, but not limited to a laptop, a palmtop, a desktop, a mobile phone, a smart phone, a television (TV), Personal Digital Assistant (PDA), a tablet, a wearable device, an Internet of Things (IoT) device, a virtual reality device, a foldable device, a flexible device and an immersive system.

In an embodiment, the electronic device 100 includes a memory 110, a processor 120, a communicator 130, image sensors 140, an image enhancement controller 150 and the display 160.

The memory 110 is configured to store an illuminance factor of viewing conditions of an original image. However, the illuminance factor of the viewing conditions is dynamic. Further, the memory 110 also stores instructions to be executed by the processor 120. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information. In certain examples, a non-transitory storage medium may store data that can, over time, change (e.g., in Random Access Memory (RAM) or cache).

The processor 120 communicates with the memory 110, the communicator 130, the image sensors 140, the image enhancement controller 150, and the display 160. The processor 120 is configured to execute instructions stored in the memory 110 and to perform various processes. The processor may include one or a plurality of processors, may be a general purpose processor, such as a central processing unit (CPU), an application processor (AP), or the like, a graphics-only processing unit such as a graphics processing unit (GPU), a visual processing unit (VPU), and/or an AI dedicated processor such as a neural processing unit (NPU).

The communicator 130 includes an electronic circuit specific to a standard that enables wired or wireless communication. The communicator 130 is configured to communicate internally between internal hardware components of the electronic device 100 and with external devices via one or more networks.

The image sensors 140 are configured to capture a scene in an ambient light condition. Pixels in the image sensors 140 include photosensitive elements that convert the light into digital data and capture the image frame of the scene. A typical image sensor may, for example, have millions of pixels (e.g., megapixels) and is configured to capture a series of image frames of the scene based on a single click input from a user. The image sensors 140 may include multiple sensors. Each of the multiple sensors in the image sensors 140 may include different focal lengths.

In an embodiment, the image enhancement controller 150 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductors. The image enhancement controller 150 includes an image analyser 151, a viewing condition analyser 152, a virtual content management controller 153, a first AI model 154a connected to a color compensation controller 155 and a second AI model 154b.

In an embodiment, the image analyser 151 is configured to receive an original image and analyse content in the original image. The image analyser 151 identifies various colors present in the original image and pixels associated with each of the colors.

In an embodiment, the viewing condition analyser 152 is configured to identify current viewing conditions associated with the original image displayed in the electronic device 100 by sensing an ambient light. The ambient light includes luminance and correlated color temperature of the ambient light. The viewing conditions associated with the electronic device 100 are dynamic and keep changing based on various factors such as for example but not limited to location of the electronic device 100, a light source under which the electronic device 100 is being operated, time of day, etc. For example, the viewing conditions and ambient light when a user is accessing the electronic device 100 under sunlight are different as compared to when the user accesses the same electronic device 100 under a LED light source. Similarly, the viewing conditions and ambient light when the user is accessing the electronic device 100 during sunrise in the morning, noon and post-sunset are all different.

In an embodiment, the virtual content management controller 153 is configured to generate a virtual content appearance of the original image based on the ambient light and characteristics of display 160 of the electronic device 100. The virtual content appearance of the original image generation includes the virtual content management controller 153 is configured to determine an illuminance factor of viewing conditions based on contents of the original image, the ambient light and the characteristics of the display 160 of the electronic device 100. Further, the virtual content management controller 153 is configured to estimate an appearance of color tone of RGB of the content in the original image based on the illuminance factor and use the estimated appearance of color tone of RGB of the content in the original image to generate the virtual content appearance of the original image using the first AI model 154a.

In an embodiment, the first AI model 154a is configured to determine the illuminance factor of the viewing conditions based on the contents of the original image, the ambient light and the characteristics of the display of the electronic device 100. The first AI model 154a is configured to determine a tri-stimulus value of a virtual illuminant of the viewing conditions using the original image, the ambient light data and the display characteristics of the electronic device 100 and determine a chromaticity co-ordinates for the virtual illuminant of the viewing conditions using the determined tri-stimulus value. Further, the first AI model 154a is configured to determine a luminance of the virtual illuminant based on a coordinate of the determined tri-stimulus value and determine the illuminance factor of the viewing condition using the tri-stimulus value and the chromaticity co-ordinates for the virtual illuminant of the viewing conditions.

To generate the virtual content appearance of the original image, the first AI model 154a is configured to concatenate the illuminance factor of the viewing conditions and the original image and determine an intermediate image using the concatenated illuminance factor and the original image as inputs to a generative adversarial networks (GAN) model. Further, the first AI model 154a is configured to determine a difference measure between the intermediate image and training images, where the training images are a plurality of versions of the original image captured using plurality of expected ambient light conditions and determine the virtual content appearance of the original image by compensating for the difference measure in the intermediate image.

In an embodiment, the color compensation controller 155 is configured to determine the compensating color tone for the original image using the virtual content appearance by performing pixel difference calculation of a color tone of the original image and a color tone of the virtual content appearance. Further, the color compensation controller 155 is configured to generate a color compensation matrix for each of R, G, B channels based on the pixel difference calculation of the color tone of the original image and the color tone of the virtual content appearance and determine the compensating color tone for the original image using the virtual content appearance based on the color compensation matrix, where the compensating color tone for the original image using the virtual content appearance allows a user to view the original image in an original color tone in the viewing condition. Further, the color compensation controller 155 is configured to determine plurality of pixels in the original image that are impacted by the ambient light based on the virtual content appearance and apply the compensating color tone for the original image to each of the plurality of pixels in the original image to modify the color tone of RGB of the content in the original image.

In an embodiment, the second AI model 154b is configured to obtain the illuminance factor of viewing conditions of the original image computed by the virtual content management controller 153. The second AI model 154b is configured to generate a color compensated original image for current viewing condition using a second AI model 156b and display the color compensated original image for the current viewing condition on the display 160.

The second AI model 154b is operative once the first AI model 154a is in place and operated for specific number of times. The second AI model 154b uses the modified images generated by the first AI model 154a for training and hence is independently operative without depending on the first AI model 154a.

A function associated with the first AI model 154a and the second AI model 154b may be performed through memory 110 and the processor 120. The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning may mean that, by applying a learning process to a plurality of learning data, a predefined operating rule or AI model of a desired characteristic is made. The learning may be performed in a device itself in which AI according to an embodiment is performed, and/or may be implemented through a separate server/system.

The first AI model 154a and the second AI model 154b may include a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), GAN, and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

The display 160 is configured to display the modified original image for current viewing condition. The display 160 is capable of receiving inputs and is made of one of LCD, LED, OLED, etc.

Although the FIG. 2 shows various hardware components of the electronic device 100 but it is to be understood that other embodiments are not limited thereon. In other embodiments, the electronic device 100 may include less or more number of components. Further, the labels or names of the components are used only for illustrative purpose and does not limit the scope of the disclosure. One or more components can be combined together to perform same or substantially similar function to digital image enhancement on the display 160.

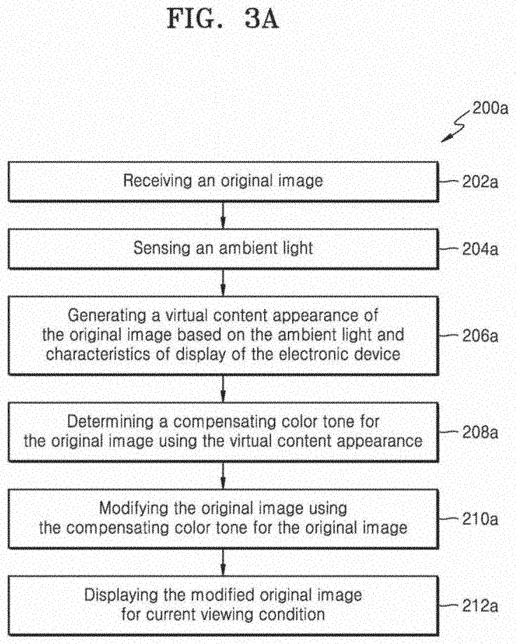

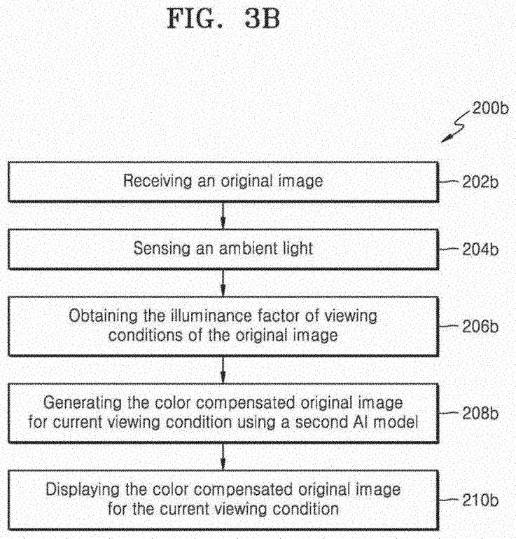

FIG. 3A is a flow diagram 200a illustrating a method for digital image enhancement on the display 160 of the electronic device 100, according to an embodiment.

Referring to the FIG. 3A, in operation 202a, the method includes the electronic device 100 receiving the original image. For example, in the electronic device 100 as illustrated in the FIG. 2, the image enhancement controller 150 is configured to receive the original image.

In operation 204a, the method includes the electronic device 100 sensing the ambient light. For example, in the electronic device 100 as illustrated in the FIG. 2, the image enhancement controller 150 is configured to sense the ambient light.

In operation 206a, the method includes the electronic device 100 generating the virtual content appearance of the original image based on the ambient light and characteristics of the display 160 of the electronic device 100. For example, in the electronic device 100 as illustrated in the FIG. 2, the image enhancement controller 150 is configured to generate the virtual content appearance of the original image based on the ambient light and characteristics of the display 160 of the electronic device 100.

In operation 208a, the method includes the electronic device 100 determining the compensating color tone for the original image using the virtual content appearance. For example, in the electronic device 100 as illustrated in the FIG. 2, the image enhancement controller 150 is configured to determine the compensating color tone for the original image using the virtual content appearance.

In operation 210a, the method includes the electronic device 100 modifying the original image using the compensating color tone for the original image. For example, in the electronic device 100 as illustrated in the FIG. 2, the image enhancement controller 150 is configured to modify the original image using the compensating color tone for the original image.

In operation 212a, the method includes the electronic device 100 displaying the modified original image for current viewing condition. For example, in the electronic device 100 as illustrated in the FIG. 2, the image enhancement controller 150 is configured to display the modified original image for current viewing condition.

The various actions, acts, blocks, steps, or the like in the flow diagram 200a may be performed in the order presented, in a different order or simultaneously. Further, in some embodiments, some of the actions, acts, blocks, steps, or the like may be omitted, added, modified, skipped, or the like without departing from the scope of the disclosure.

FIG. 3B is a flow diagram 200b illustrating a method for digital image enhancement on the display 160 of the electronic device 100, according to an embodiment.

Referring to the FIG. 3B, in operation 202b, the method includes the electronic device 100 receiving the original image. For example, in the electronic device 100 as illustrated in the FIG. 2, the image enhancement controller 150 is configured to receive the original image.

In operation 204b, the method includes the electronic device 100 sensing the ambient light. For example, in the electronic device 100 as illustrated in the FIG. 2, the image enhancement controller 150 is configured to sense the ambient light.

In operation 206b, the method includes the electronic device 100 obtaining the illuminance factor of viewing conditions of the original image. For example, in the electronic device 100 as illustrated in the FIG. 2, the image enhancement controller 150 is configured to obtain the illuminance factor of viewing conditions of the original image.

In operation 208b, the method includes the electronic device 100 generating the color compensated original image for current viewing condition using the second AI model 154b. For example, in the electronic device 100 as illustrated in the FIG. 2, the image enhancement controller 150 is configured to generate the color compensated original image for current viewing condition using the second AI model 154b.

In operation 210b, the method includes the electronic device 100 displaying the color compensated original image for the current viewing condition. For example, in the electronic device 100 as illustrated in the FIG. 2, the image enhancement controller 150 is configured to display the color compensated original image for the current viewing condition.

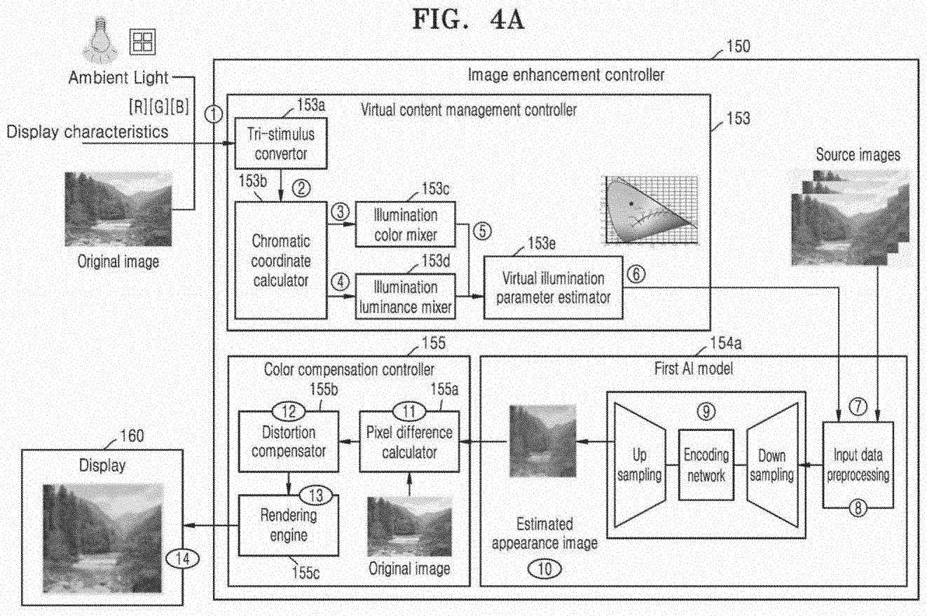

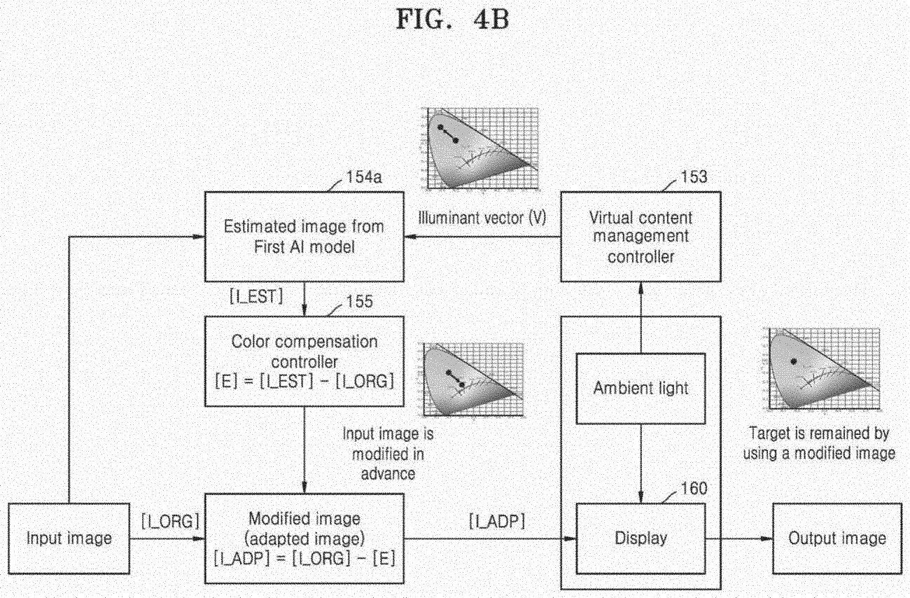

FIG. 4A is a diagram of a process flow for the digital image enhancement on the display 160 of the electronic device 100, according to an embodiment.

FIG. 4B is a diagram of a conceptual block diagram for the digital image enhancement on the display 160 of the electronic device 100, according to an embodiment as disclosed herein. The FIG. 4B is a different representation of the process flow illustrated in the FIG. 4A.

In general, light perceived by user is a combination of light emitted by the display 160 and the ambient light reflected on the display surface 160. Therefore, it is required to accommodate the effect of the ambient light on the color perceived. Referring to the FIG. 4A, the virtual content management controller 153 includes a tri-stimulus convertor 153a, a chromatic coordinate calculator 153b, an illumination color mixer 153c, an illumination luminance mixer 153d) and a virtual illumination parameter estimator 153e.

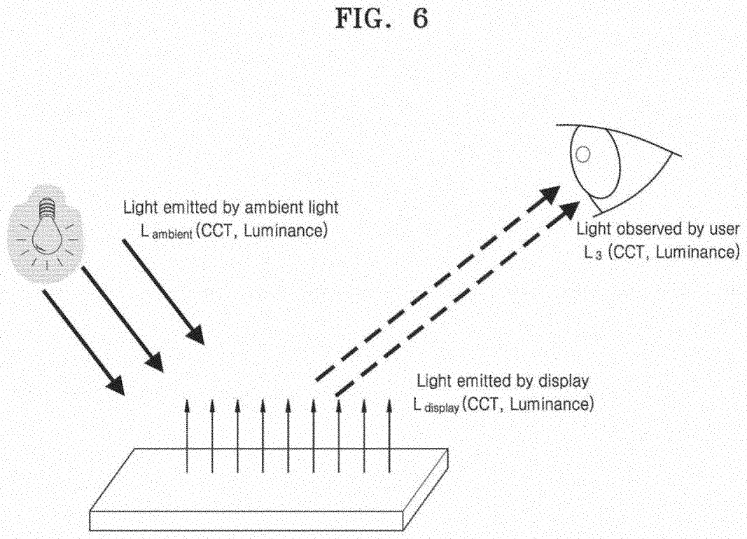

In operation 1, the tri-stimulus convertor 153a receives the sensed ambient light, the characteristics of the display 160 and the original image. In operation 2, the tri-stimulus convertor 153a determines a tri-stimulus value (X, Y, Z) for virtual illuminant of the viewing conditions and sends the tri-stimulus value (X, Y, Z) to the chromatic coordinate calculator 153b. The chromatic coordinate calculator 153b determines the chromaticity co-ordinates for the virtual illuminant of the viewing conditions using the determined tri-stimulus value, as explained in detail the FIG. 6. The virtual illuminant of the viewing conditions represents the mixed effect as perceived by the user and is parameterized by the Chroma (xᵥᵢᵣₜ, yᵥᵢᵣₜ) and the Luminance (Φᵥᵢᵣₜ) as in Equation (1):

[Xᵥᵢᵣₜ,Φᵥᵢᵣₜ]=Fn(L_{image},L_{display device},L_{ambient light}) (1)

where L_{image} is luminance of the image, L_{display device} luminance of the display device and L_{ambient} light is luminance of the ambient light.

In operation 3 and operation 4, the chromatic coordinate calculator 153b sends the chromaticity co-ordinates for the virtual illuminant of the viewing conditions to an illumination color mixer 153c and an illumination luminance mixer 153d respectively. In operation 5, a virtual illumination parameter estimator 153e receives the color from the illumination color mixer 153c and the luminance from the illumination luminance mixer 153d and in operation 6, determines the illuminance factor of the original image using the tri-stimulus value and the chromaticity co-ordinates for the virtual illuminant of the viewing conditions.

The electronic device 100 includes the first AI model 154a which in operation 7 receives the illuminance factor of the original image and multiple source images captured in similar viewing conditions. In operation 8, the input data received in operation 7 is subjected to pre-processing. Further, in operation 9, the pre-processed input data is down sampled, encoded and up sampled to obtain the estimated appearance image, in operation 10.

In operation 11, a pixel difference calculator 155a of the color compensation controller 1555 receives the estimated virtual appearance image [I_EST] and the original image [I_ORG] as inputs and determines the pixel difference of the color tone of the original image and the color tone of the virtual content appearance [E]=[I_EST]−[I_ORG]. In operation 12, a distortion compensator 155b generates a color compensation matrix for each of R, G, B channels based on the pixel difference calculation of the color tone of the original image and the color tone of the virtual content appearance [E]=[I_EST]−[I_ORG] and determines compensating color tone for the original image using the virtual content appearance based on the color compensation matrix. In operation 13, a rendering engine 155c applies the determined compensating color tone for the original image to obtain an adapted image [I_ADP]=[I_ORG]−[E] and in operation 14, the rendering engine 155c renders the adapted image [I_ADP] on the display 160 of the electronic device 100. The compensating color tone for the original image using the virtual content appearance allows the user to view the original image in the original color tone in the viewing condition.

Therefore, the method determines the viewing condition by calculating combined effect of display characteristics, ambient light data (e.g., chroma and luminance) and image data (luminance levels and Chroma data. The interaction of the parameters as mixed luminance and Chroma is represented by the illuminant factor.

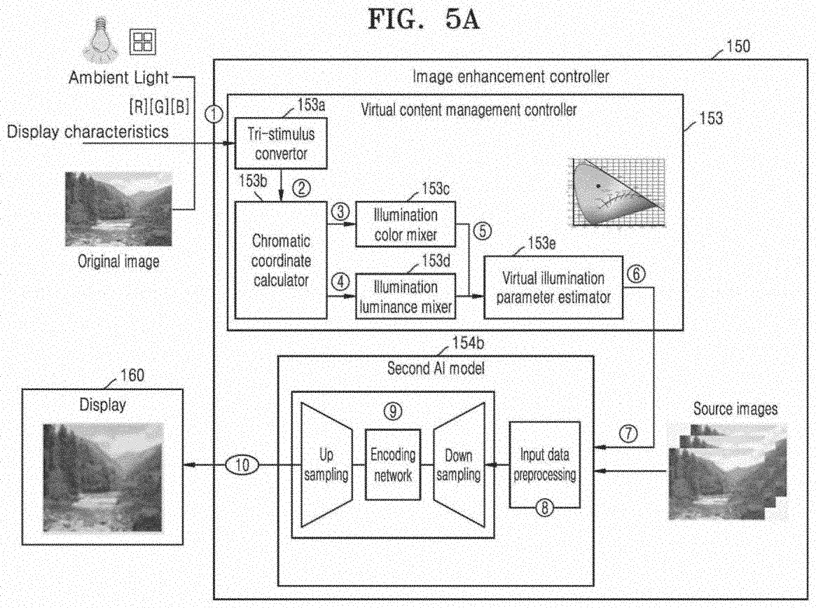

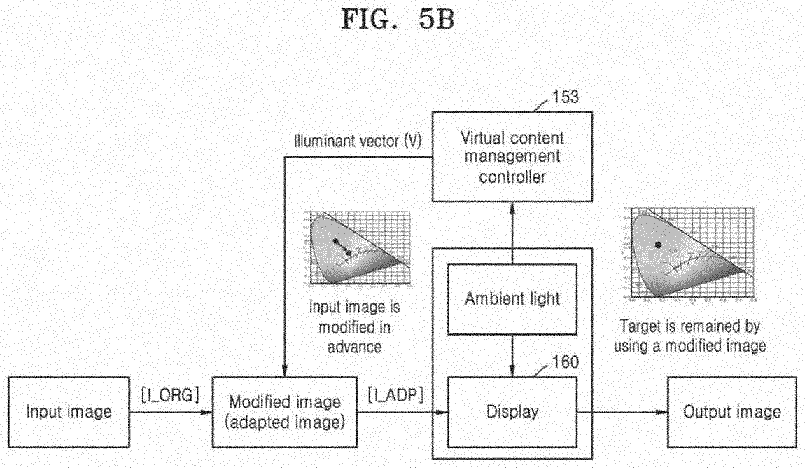

FIG. 5A is a diagram of process flow for the digital image enhancement on the display 160 of the electronic device 100, according to an embodiment.

FIG. 5B illustrates a block diagram for the digital image enhancement on the display 160 of the electronic device 100, according to an embodiment. The FIG. 5B is a different representation of the process flow illustrated in the FIG. 5A.

Referring to the FIG. 5A in conjunction with the FIG. 3A, the operation to operation 6 in the FIG. 5A are substantially the same as the operation 1 to operation 6 in the FIG. 4A and hence repeated description is omitted. In operation 7, the second AI model 154b receives the illuminance factor of the original image [I_ORG] and multiple source images captured in similar viewing conditions. In operation 8, the input data received in operation 7 is subjected to pre-processing. Further, in operation 9, the pre-processed input data is down sampled, encoded and up sampled to directly obtain the adapted image [I_ADP], in operation 10.

This process flow may be followed once the process flow described in the FIG. 4A is operational and has generated multiple modified images for a given viewing condition. The second AI model 154b uses the multiple modified images generated for the given viewing condition for learning and hence the need for color compensation is eliminated in this process flow as compared to the process flow described in the FIG. 4A. Therefore, once the process flow described in the FIG. 4A is operational for a specific duration of time, the process flow described in the FIG. 5A can take over, thereby further reducing the processing resource requirements.

FIG. 6 is a diagram of the virtual content management controller 153 configured to generate the illuminance factor of the viewing condition, according to an embodiment.

Referring to the FIG. 6, due to an additive nature of photometry and colorimetry, the perceived illumination can be represented as the illuminance factor of the viewing condition. A target viewing environment can be characterized by an effective luminance and CCT which are defined as a weighted sum of individual components of the effective luminance and the CCT.

The method includes determining the tri-stimulus value of the virtual illuminant of the viewing conditions using the original image, the ambient light data and the characteristics of the display 160 of the electronic device 100.

The tri-stimulus value (X, Y, Z) for the virtual illuminant of the viewing conditions is calculated as in Equations (2), (3), and (4):

Xᵥᵢᵣₜ=X_{image}+X_{display device}+X_{ambient light} (2)

Yᵥᵢᵣₜ=Y_{image}+Y_{display device}+Y_{ambient light} (3)

Z_{_virt}=Z_{image}+Z_{display device}+Z_{ambient light} (4)

Further, the electronic device 100 determines the chromaticity co-ordinates (xᵥᵢᵣₜ, yᵥᵢᵣₜ) for the CCT_{_virt} of the virtual illuminant of the viewing conditions using the determined tri-stimulus value is calculated as in Equations (5), (6) and (7):

Xᵥᵢᵣₜ=Xᵥᵢᵣₜ/(Xᵥᵢᵣₜ+Yᵥᵢᵣₜ+Zᵥᵢᵣₜ) (5)

Yᵥᵢᵣₜ=Yᵥᵢᵣₜ/(Xᵥᵢᵣₜ+Yᵥᵢᵣₜ+Zᵥᵢᵣₜ) (6)

And luminance as Φᵥᵢᵣₜ=Y_{image}+Y_{display device}+Y_{ambient light} (7)

Thus, the virtual illuminant of the viewing conditions will result in the illuminant factor/illuminant vector.

For example, consider that the input image with size of 28×28, virtual illuminant is CCTᵥᵢᵣₜ=3000K, luminance 265 lux (Φᵥᵢᵣₜ=0.265) and chromaticity coordinate xᵥᵢᵣₜ=0.4351 yᵥᵢᵣₜ=0.4146, Y=0.265.

Illuminant factor/illuminant vector for the image 28×28 is, as in Equation (8):

$${( \begin{matrix}0.4315 & 0.4315 & 0.4315 & … & … & … & . & . & 0.4315 \\ 0.4146 & 0.4146 & 0.4146 & … & … & … & . & . & 0.4146 \\ 0.265 & 0.265 & 0.265 & … & … & … & . & & 0.265\end{matrix} )}_{3 \times 28} \qquad ( 8 )$$

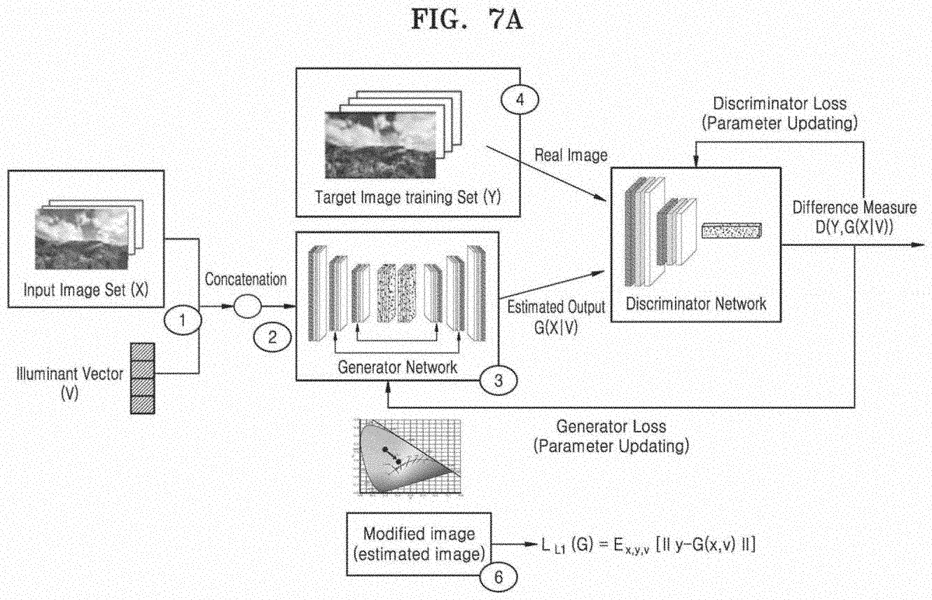

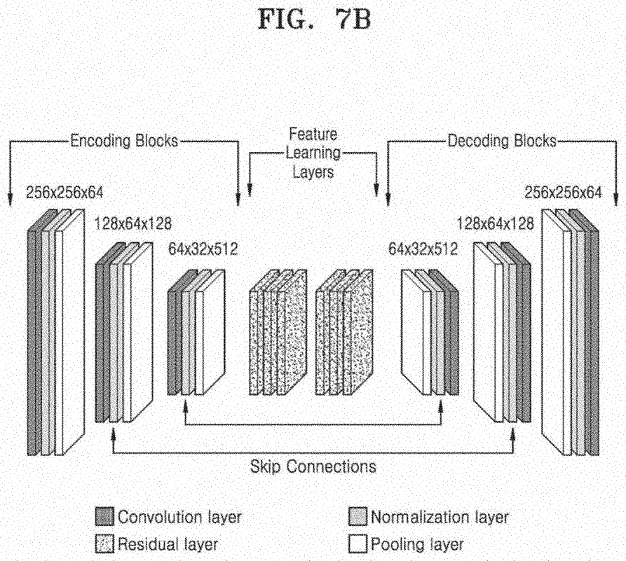

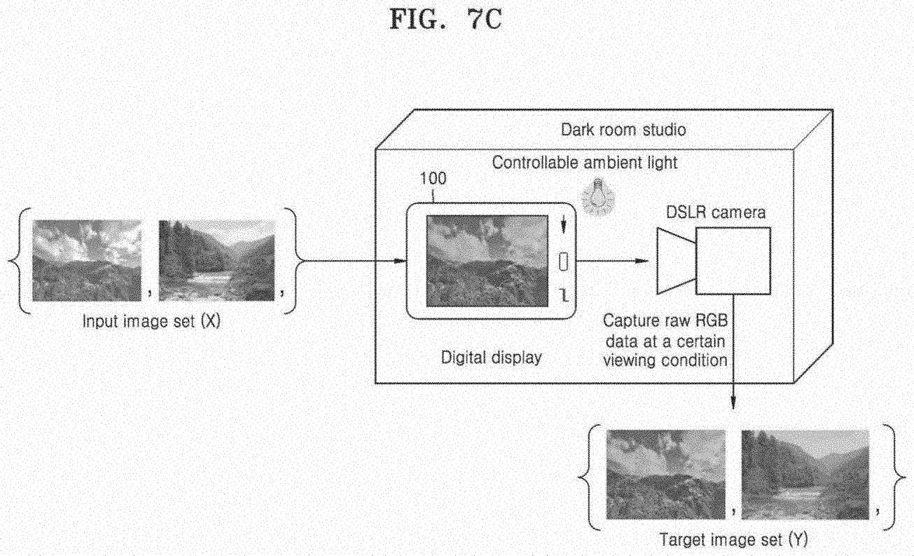

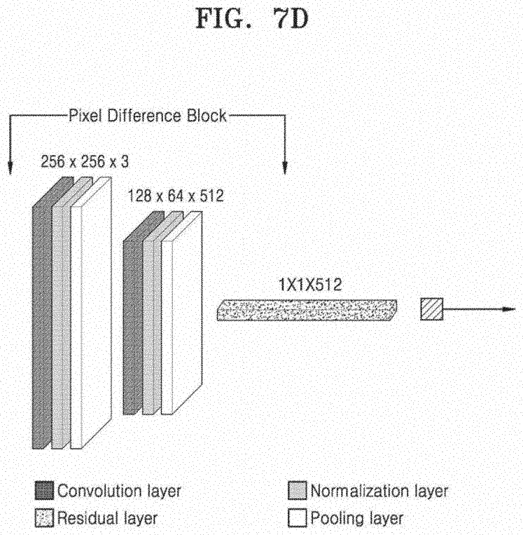

FIG. 7A is a diagram of various components of the first AI model 154a for determining the virtual content appearance of the original image, according to an embodiment as disclosed herein.

In general, pixel color distortion perceived by user is affected by Chroma and luminance of surrounding pixels so the effect of the Chroma and luminance of surrounding pixels needs to be considered and corrected. The chromatic and achromatic shift is modelled using a conditional GAN. The generator and discriminator will be conditioned by the input image data concatenated with the illuminant vector v. The illuminant vector v consists of values of chromaticity coordinates and luminance of the ambient light source which is extracted by the viewing condition analyser 152.

The conditional generative adversarial network, or cGAN, is a type of GAN that involves the conditional generation of images by a generator model. In the method, using a cGAN the estimated appearance of the original image will be generated based on the conditional input that will be applied to both Generator and Discriminator network. The condition will be the viewing environment illuminant data and therefore the images generated will be targeted for the viewing environment as given in the illuminant vector.

Referring to the FIG. 7A, in operation 1 the first AI model 154a receives the illuminant factor/vector and the input image set (X). In operation 2, the first AI model 154a concatenates the illuminant factor/vector (V) and the input image set (X). To concatenate the illuminant factor/vector (V) several techniques can be used. One way is to apply an additional channel to the original image consisting of the vectored values of the illuminant factor/vector (V), or the illumination vector can be appended to one of the dimensions of the original image. Conditioning the generator is required as the effect of same ambient light is highly dependent on the value of color being displayed as well as the surrounding pixels. Hence, it allows the generator to learn the best possible effect of the ambient light represented by the illuminant vector on the different pixel color distribution of the original image, and helps to make sure that the generated output is highly correlated to the original image while being able to best predict the change in the Chroma of the image due to the ambient light.

In operation 3, a generator network of the first AI model 154a receives the concatenated data and generates an intermediate image using the concatenated illuminance factor and the original image as inputs to a GAN model. The intermediate image is indicated as estimated output G (X|V) and is sent to a discriminator network of the first AI model 154a.

The generator network can be implemented using convolution-BatchNorm-rectified linear units (ReLU) Blocks to form an Encoder-Decoder Model. In this appearance estimation problem, the input and output differ in surface appearance which is the Chroma but both have similar image content so the skip connections are used to improve training speed. The discriminator network is implemented by stacking blocks of Conv-BatchNorm-LeackyReLU, which outputs one number (a scalar) representing how much the model thinks the input (which is the whole image) is real (or fake).

Further, in operation 4, the training images are received by a discriminator network of the first AI model 154a. The training images are a plurality of versions of the original image captured using plurality of expected ambient light conditions. In operation 5, the discriminator network determines difference measure between the intermediate image and the multiple training images. The difference measure is indicated as D (Y, G (X|V)). The discriminator network also receives a discriminator loss (parameter updating) based on the difference measure calculation, which helps the discriminator network to generate the difference measure precisely. Also, the generator receives a generator loss (parameter updating) based on the difference measure calculation, which helps the generator network to generate the intermediate images with higher precision.

In operation 6, the electronic device 100 determines the virtual content appearance of the original image by compensating for the difference measure in the intermediate image.

For the method with Generator G, discriminator D, input image x, illumination vector v and required output y, the Loss formulation is, as in Equation (9).

L_{cGAN}(G,D)=E[log(D(y,v))]+E[log(1−D(G(x,v)))] (9)

To improve bluffing effect a L1 loss is introduced between the generated and the required output, as in Equation (10):

L_{L1}(G)=E_{x,y,v}[∥y−G(x,v)∥] (10)

Therefore, the final objective function is, as in Equation (11):

G=arg min_{G} max_{D} L_{cGAN}(G,D)+L_{L1}(G) (11)

Further, the conditional GAN can be stabilized by one of stride convolutions, which improve efficiency for up/down sampling; batch normalization, which improves training stability and avoid vanishing and exploding of gradient parameters, ReLU, Leaky ReLU, and Tan h, which improve training stability and Adam optimization.

FIG. 7B is a diagram of various layers of the generator network of the first AI model 154a, according to an embodiment.

Referring to the FIG. 7B, the generator network of the first AI model 154a includes encoding blocks, feature learning layers and decoding blocks. The generator network receives the concatenated illuminance factor and the original image as inputs and generates the intermediate image is indicated as the estimated output G (X|V).

The generator network is trained on dataset consisting of a pair of image: one in D65 light and the other of the same image viewed in the illuminant (V). After training, the generator learns the image transformation matrix for features like: Brightness, Lightness, Colourfulness, Chroma, Saturation, Hue angle, Hue composition etc.

FIG. 7C is a diagram of target image generation process in the first AI model 154a, according to an embodiment.

Referring to the FIG. 7C, in conjunction with the FIG. 7A, in operation 4 of the FIG. 7A, the target image training set (Y) is used. The target image training set (Y) generation procedure is explained further. A setup for the generation of the target image training set (Y) includes the input image set (X), a dark room setup, a digital single-lens reflex (DSLR) camera with raw image output and the digital display.

The input image set (X) is a set of images of standard resolution, for example but not limited to 1080p resolution. The input set includes variety of images such as for example but not limited to multiple images of indoor condition, multiple images of outdoor condition, multiple images indicating different times of day and multiple images including various main subjects such as for example people, nature, man-made objects, etc. The input set includes standard color assessment images like MunsellColorCheckerchart as it includes all standard colors easily differentiable by human eye. The input set includes solid colors like Red, Blue and Green.

The dark room setup includes industry standard room or light booth equipped with multiple light sources for color assessment. The luminance and CCT of the light source may be adjusted. The dark room setup includes spectro-radiometer for luminance measurement. A dark room setup includes Chroma meter for the CCT measurement.

The DSLR camera with raw image output is capable of capturing minimum of 1080p images and should allow raw image output (i.e., no camera image processing algorithms should affect image). The digital display is capable of displaying the 1080p images captured by the DSLR camera. Further, the digital display allows the users to disable image processing for best results.

The target image generation steps setting up the apparatus as shown in the FIG. 7C. The method then includes displaying the input image xᵢ on digital display. Then the ambient light color temperature and the luminance are adjusted. Further, the images of the displayed input image are captured using the DSLR camera and the raw image is stored as yᵢ. The present luminance and the CCT of the room are noted and stored as vector vᵢ. Further, the method may include storing, as the training set input, the target condition as: {xᵢ, yᵢ, vᵢ}.

Then the above mentioned procedure is repeated by changing the ambient light CCT and the luminance combination by simulating daily lighting experiences. The procedure is repeated for different images in the input set X.

FIG. 7D is a diagram of various layers of the discriminator network of the first AI model 154a, according to an embodiment as disclosed herein.

Referring to the FIG. 7D, the discriminator is adjusted to consider patch wise difference between the generated and the required image to adjust for pixel distortion. The compensation for a specific pixel should be a function of the surrounding pixels. A same color can have different Adjustment as the luminance of the surrounding pixels affects the perceived color. Hence, the first AI 154a is conditioned to learn Chroma transformation based on the viewing condition luminance and Chroma (vector v).

Therefore, the first AI model 154a estimates the appearance of the original image in the ambient condition. The first AI model 154a will predict how the color will appear to be shifted due to the ambient lighting, device settings etc. which has a different color temperature as compared to the original image. All colors of a color space can be modelled to find out how the original image colors will appear in a new virtual illuminant with different color temperature and luminance.

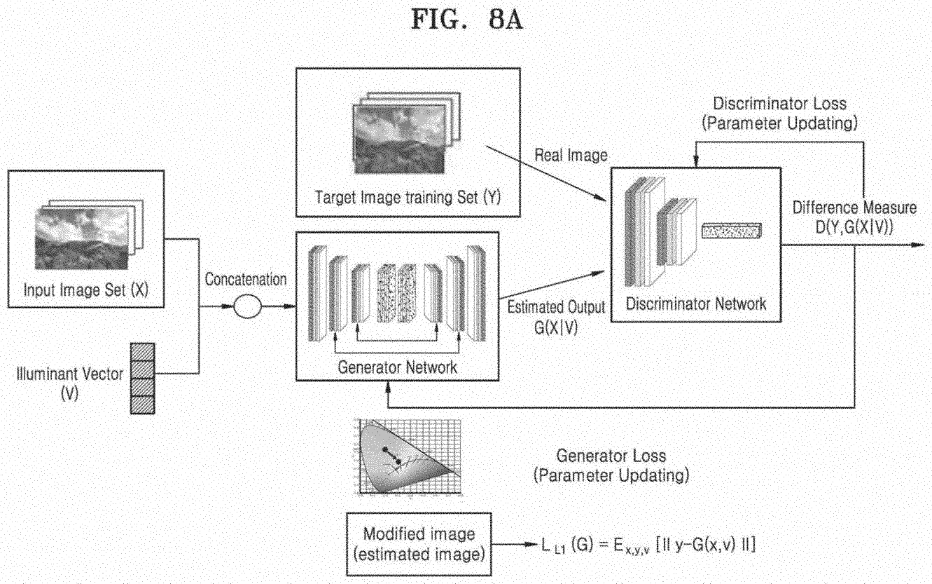

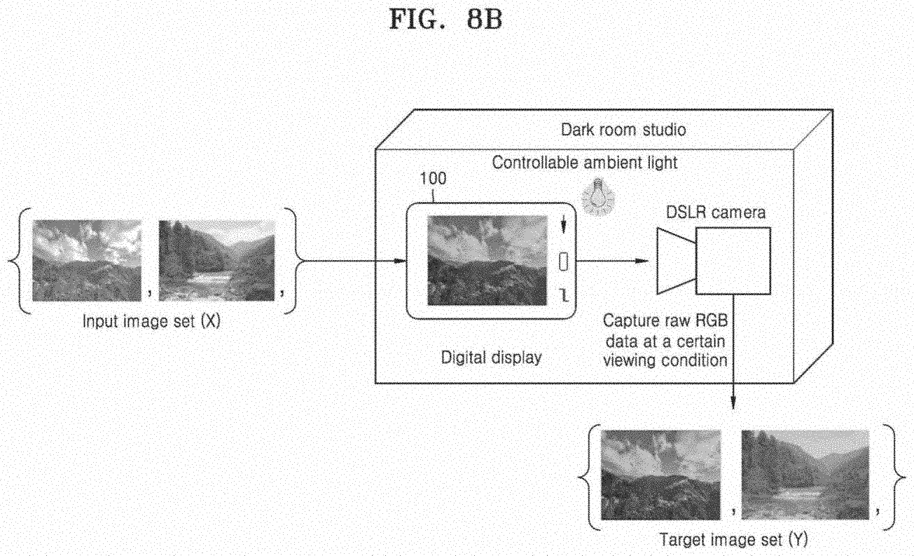

FIG. 8A is a diagram various components of the second AI model 154b for obtaining the color compensated original image for the current viewing condition, according to an embodiment.

Referring to the FIG. 8A, in operation 1 the second AI model 154b receives the illuminant factor/vector which was computed for the process flow associated with the first AI model 154a and the input image set (X). In operation 2, the second AI model 154b concatenates the illuminant factor/vector (V) and the input image set (X). In operation 3, a generator network of the second AI model 154b receives the concatenated data and generates a second intermediate image using the concatenated illuminance factor and the original image as inputs to the GAN model. The second intermediate image is indicated as estimated output G (X|V) and is sent to a discriminator network of the second AI model 154b.

Further, in operation 4, the training images are received by a discriminator network of the second AI model 154b. The training images are a plurality of modified original images from the first process flow. In operation 5, the discriminator network determines difference measure between the second intermediate image and the multiple training images. The difference measure is indicated as D (Y, G (X|V)). The discriminator network also receives a discriminator loss (parameter updating) based on the difference measure calculation, which helps the discriminator network to generate the difference measure precisely. Also, the generator receives a generator loss (parameter updating) based on the difference measure calculation, which helps the generator network to generate the intermediate images with higher precision.

In operation 6, the electronic device 100 determines the color compensated original image for current viewing condition by compensating for the difference measure in the second intermediate image. The virtual content appearance is indicated as L_{L1} (G)=E_{x,y,v} [∥y−G(x,v)∥].

FIG. 8B is a diagram of target image generation process in the second AI model 154b, according to an embodiment.

Referring to the FIG. 8B, in conjunction with the FIG. 7C, the target image generation setup is same as explained in the FIG. 7C and hence repeated description is omitted. However, the target image generation procedure is explained below. The input image x is displayed on the digital display and the ambient light color temperature and the luminance are adjusted. In case of the second process flow, the input image is the modified image finally obtained out of the first process flow (i.e., the images used for training the second AI model 154b is the output from the first process flow). Further, the image of the displayed input image is captured using the DSLR camera. The raw image is stored as yᵢ. Further, the method may include recording the present luminance and the CCT of the room and storing the same as vector vᵢ. Then, store as training set input, target, condition as: {xᵢ, yᵢ, vᵢ}. The above explained procedure is repeated for different ambient light CCT and the luminance combination by simulating daily lighting experiences. The steps are repeated for different images in input set X.

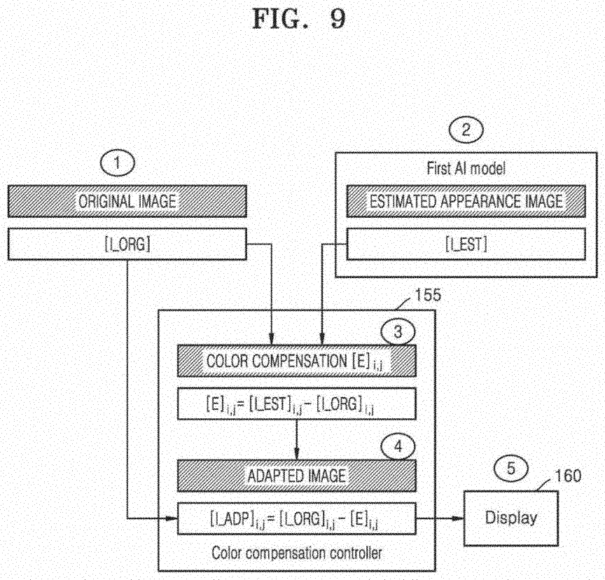

FIG. 9 is a diagram of the color compensation controller 155 in the first process flow for determining the virtual content appearance of the original image, according to an embodiment as disclosed herein.

Referring to the FIG. 9, the color compensation controller 155 is associated with the first process flow for determining the digital enhancement on the display 160 and the same does not exist as part of the second process flow. In operation 1, a matrix of the original image [I_ORG] is received by the color compensation controller 155. In operation 2, the estimated appearance image [I_EST] determined by the first AI model 154a is received by the color compensation controller 155.

In operation 3, the color compensation controller 155 generates the color compensation matrix for all the R, G, B channels based on the color difference between the estimated appearance image and the original image. [E]_{i,j} is the value of distortion calculated for pixel (i,j) of original image in the current viewing condition as in Equation (12):

[E]_{i,j}=[I_EST]−[I_ORG] (12)

where i,j denotes the pixel coordinate; 0<=i<=image_height and 0<=j<=image_width.

Further, in operation 4, the [E]_{i,j} is applied to the original image to generate the adapted image for the current viewing condition, as in Equation (13).

[I_ADP]_{i,j}=[I_ORG]_{i,j}−[E]_{i,j} (13)

In operation 5, the adapted image for the current viewing condition is displayed on the display 160 of the electronic device 100. Therefore, the color compensation controller 1555 determines the compensation of the R, G, B components to be applied to the original image. RGB correction curves are determined by the color compensation controller 1555 using the output of the estimated image from the first AI model 154a. The color compensation controller 1555 models the chromatic and achromatic shift which occurs on the pixels displayed in the given ambient condition. The correction is calculated by adjusting the pixel wise difference between R, G, B channels of the estimated image and the original image.

Further, the method applies the correction to the original image for the R, G, B channels and the pixel wise compensation to correct the local Chroma and the luminance distortions. Also, the RGB tone correction curves in the method only affects the pixel values of the image data and does not replace the tone mapping function of the display 160.

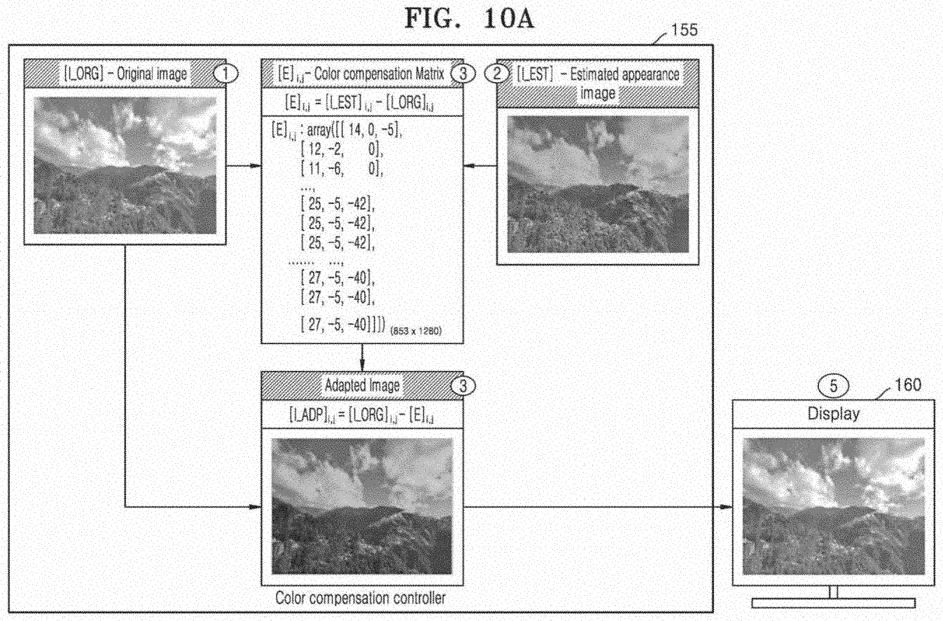

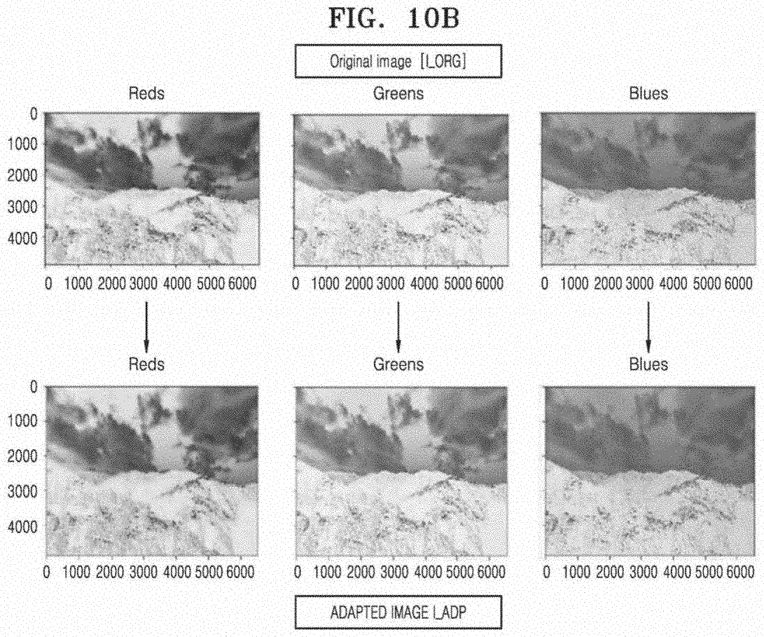

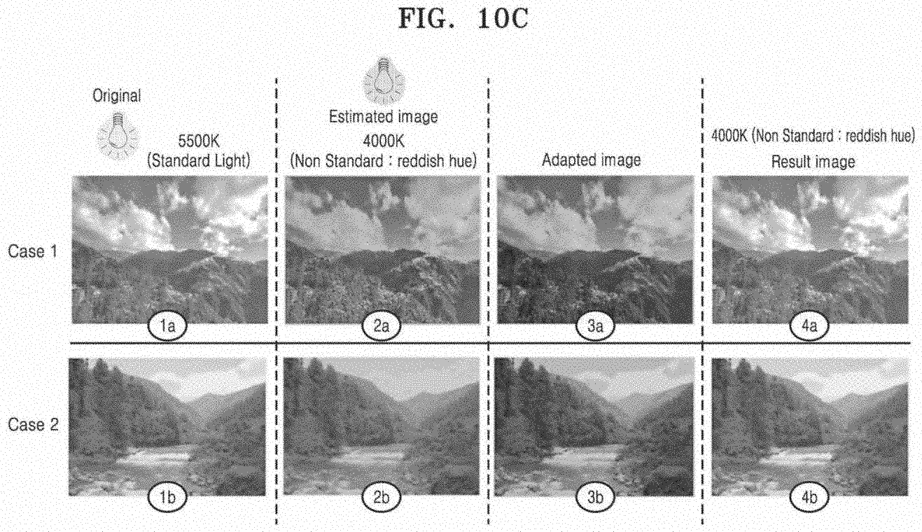

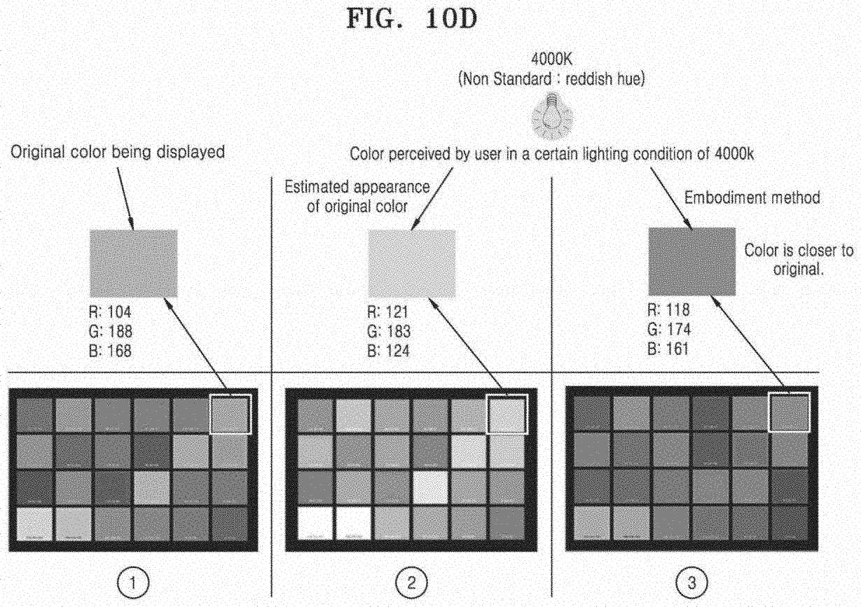

FIG. 10A is a diagram illustrating the generation of the adapted image for the current viewing condition by the color compensation controller 155 in the first process flow, according to an embodiment as disclosed herein.

Referring to the FIG. 10A, consider a scenario where the ambient light temperature is 4000K and the original image has size of 853×1280. In operation 1, the color compensation controller 155 receives the original image [I_ORG] as captured in the ambient light condition. In operation 2, the color compensation controller 155 receives the estimated appearance image [I_EST] from the first AI model 154a. The estimated appearance image is a version of the original image that would have been displayed to the user in the ambient light condition of 4000K in without enhancement of the original image as disclosed herein.

In operation 3, the color compensation controller 155 generates the color compensation matrix [E]_{i,j} for all the R, G, B channels based on the color difference between the estimated appearance image and the original image as in Table 1:

TABLE 1

[E]_{i,j}: array ([[[14, 0, −5],
[12, −2, 0],
[11, −6, 0],
. . . ,
[25, −5, −42],
[25, −5, −42],
[25, −5, −42]],
. . . . . . ,
[27, −5, −40],
[27, −5, −40],
[27, −5, −40]]])_{(853 ×1280)}

In operation 4, the [E]_{i,j} is applied above to the original image to generate the adapted image for the current viewing condition and the adapted image for the current viewing condition is displayed on the display 160 of the electronic device 100 (in operation 5).

FIG. 10B is a diagram illustrating R, G, B components of the original image and the adapted image, according to an embodiment.

Referring to the FIG. 10B in conjunction with the FIG. 10A, a comparison illustrating the R, G, B components of the original image and the adapted image are provided. It can be observed that the changes in the R, G, B components of the original image has been adapted as expected as shown in the adapted image, indicating the efficiency of the method for digital enhancement of the image.

The change in the R, G, B components of the original image and the adapted image indicates the compensation applied such that when the adapted image is displayed on the display 160 of the electronic device 100 in the current viewing condition, the image displayed will appear similar to the original image. Therefore, since the method takes into consideration the ambient light, the display characteristics, etc. into consideration and determines the estimated appearance of the original image in the current viewing condition. Then, the method modifies the original image based on the estimated appearance of the original image in the current viewing condition to compensate for the changes in color that would be created in the original image due to the ambient light. As a result, the effect of the ambient light on the original image is reduced before the original image is displayed on the display 160 of the electronic device 100.

FIG. 10C is a diagram illustrating various versions of the original image during the digital image enhancement, according to an embodiment.

Referring to the FIG. 10C, consider a case 1 and case 2 where two different images are taken into consideration. In operation 1a and operation 1b, original image is captured at ambient light condition of 5500K standard light. The original images are as shown in the operations 1a and 1b. Consider that the viewing condition is at 4000K with a non-standard light with a reddish hue. Then in operation 2a and operation 2b, the electronic device 100 determines the estimated image (i.e., the original image displayed in the viewing condition at 4000K in the absence of the method for digital image enhancement). Therefore, if the method is not incorporated in the electronic device 100, then the original image would appear as provided in the operation 2a and the operation 2b when displayed on the display 160 of the electronic device 100. It can be observed that the reddish hue present in the viewing condition is reflected in the estimated image as well.

With the incorporation of the method, the electronic device 100 after determining the estimated image determines the color compensation that needs to be applied to the original image to overcome the reddish hue of the environment. Then the adapted image is generated as seen in the operation 3a and the operation 3b. Further, the adapted image is displayed on the display 160 of the electronic device 100 in the current viewing condition, as indicated in operation 4a and operation 4b. It can be observed that the image displayed appears very close to the original image and the reddish hue present in the viewing condition does not affect the display of the original image.

FIG. 10D is a diagram illustrating perception of a color in various viewing conditions, according to an embodiment as disclosed herein.

Referring to the FIG. 10D, in operation 1, consider that a ground truth color checker is viewed at 5500K with R, G, and B values as 104, 188 and 168, respectively. Consider that the color checker is viewed in 4000K viewing condition. Then the appearance of the color checker changes. At 2, the possible change in appearance of the color checked at the 4000K viewing condition is estimated by the first AI model 154a. With this solution, when the chromatically adapted image is viewed in the ambient light condition of the 4000K, the specific color will be perceived like the color in the original image, as shown at 3.

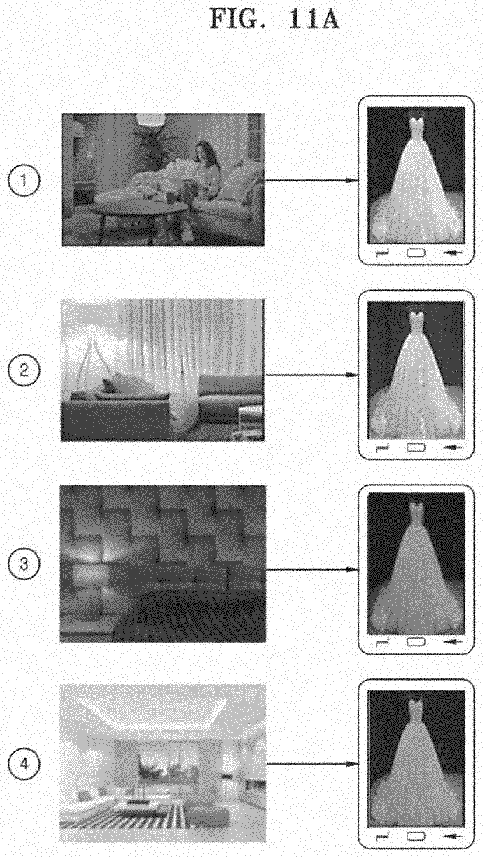

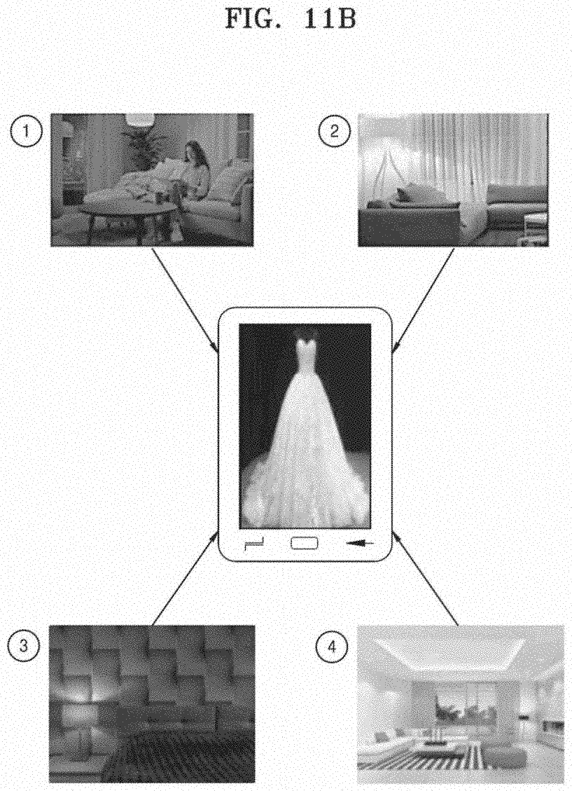

FIG. 11A is a diagram illustrating a scenario of an image perceived in different viewing conditions, according to related art.

Referring to the FIG. 11A, consider that multiple users are circulating and viewing an image of a white gown. At 1, consider that the users are viewing under a warm and red lighting condition. Then the white gown does not appear white rather appears with a reddish hue. Similarly, at 2 the users viewing the white gown under yellow lighting condition perceive the white gown to be a yellow gown due to the yellow hue. At 3, the users view the white gown as pink due to pink light in their viewing condition which impacts the color of the white gown being displayed on the electronic device of the users. Similarly, at 4, the white gown is perceived as a purple gown by the users due to the purple light in the viewing condition. Therefore, the users generally perceive the color of the white gown based on their respective lighting condition. As a result the user experience is dependent on the lighting condition and is perceived differently by different users which degrade the user experience. In the above scenario if the users are planning to buy the white gown, then the users may skip the white gown perceiving the white gown based on their lighting condition which is not right.

FIG. 11B is a diagram illustrating a scenario of the image perceived in different viewing conditions, according to an embodiment.

Referring to the FIG. 11B in conjunction with the FIG. 11A, the electronic device 100 determines the ambient light condition and the characteristics of the display 160 and uses the data to modify the original image before displaying the original image. As a result, in all scenarios from 1 to 4 the white gown appears white without the impact of the viewing condition. Therefore, the method provides consistent color to be perceived by the users across any type of the lighting condition in which the original image is being viewed.

Similarly, the method may be used in retail digital signage to deliver real-to-life, eye-catching picture quality and a redefined in-store experience to cut through the clutter and capture the attention of shoppers. The method will provide a more consistent color description of the products throughout the inconsistent lighting within the shopping malls.

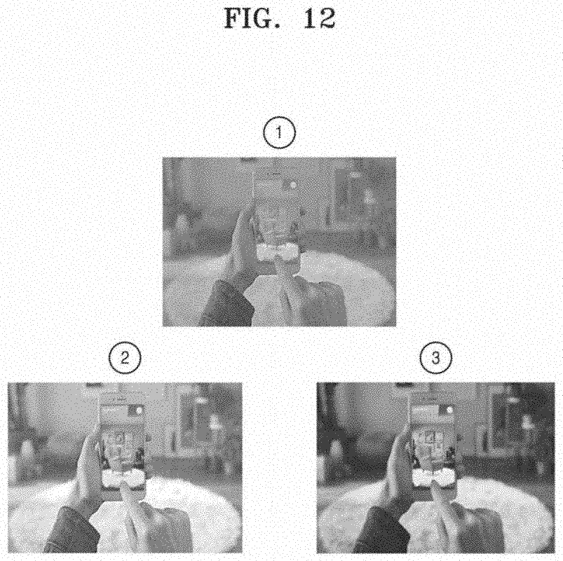

FIG. 12 is a diagram illustrating a scenario of the image of a product perceived during online shopping, according to an embodiment as disclosed herein.

Referring to the FIG. 12, online shopping has gained a lot of momentum due to easy access to a variety of products at the fingertips of the users. But many times, the color of the objects viewed in the electronic device 100 appear different from the actual color due to the varied lighting condition. As a result, a user's Quality of Experience is degraded (as shown in 1 and the original image is distorted by the viewing condition.

With the incorporation of the method, the electronic device 100 modifies the original image by taking into consideration the ambient light conditions and the characteristics of the display 160 before displaying the original image. As a result, the modified image is adapted to the ambient light conditions and the characteristics of the display 160 and appears similar to the original image with the true colors of the objects viewed in the electronic device 100 retained across varied lighting condition. Therefore, the method eliminates the need for any high end color calibration hardware or process to be incorporated in the electronic device 100.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for digital image enhancement on a display of an electronic device, the method comprising:
receiving, by the electronic device, an original image;
sensing, by the electronic device, an ambient light;
generating, by the electronic device, a virtual content appearance of the original image based on the ambient light and characteristics of the display of the electronic device;
determining, by the electronic device, a compensating color tone for the original image based on the virtual content appearance;
modifying, by the electronic device, the original image based on the compensating color tone for the original image; and
displaying, by the electronic device, the modified original image for a current viewing condition.

2. The method of claim 1, wherein generating the virtual content appearance of the original image comprises:
determining, by the electronic device, an illuminance factor of viewing conditions based on content of the original image, the ambient light and the characteristics of the display of the electronic device;
estimating, by the electronic device, an appearance of a color tone of the content in the original image based on the illuminance factor of the viewing conditions; and
generating, by the electronic device, the virtual content appearance of the original image based on the estimated appearance of the color tone of the content in the original image using a first artificial intelligence (AI) model.

3. The method of claim 2, wherein determining, by the electronic device, the illuminance factor of the viewing conditions comprises:
determining, by the electronic device, a tri-stimulus value of a virtual illuminant of the viewing conditions based on the original image, ambient light data and the characteristics of the display of the electronic device;
determining, by the electronic device, chromaticity co-ordinates for the virtual illuminant of the viewing conditions based on the determined tri-stimulus value;
determining, by the electronic device, a luminance of the virtual illuminant based on a coordinate of the determined tri-stimulus value; and
determining, by the electronic device, the illuminance factor of the viewing conditions based on the tri-stimulus value and the chromaticity co-ordinates for the virtual illuminant of the viewing conditions.

4. The method of claim 2, wherein generating, by the electronic device, the virtual content appearance of the original image comprises:
concatenating, by the electronic device, the illuminance factor of the viewing conditions and the original image;
determining, by the electronic device, a first intermediate image based on the concatenated illuminance factor and the original image as inputs to a generative adversarial network (GAN) model;
determining, by the electronic device, a difference measure between the first intermediate image and training images, wherein the training images comprise a plurality of versions of the original image captured using a plurality of expected ambient light conditions; and
determining, by the electronic device, the virtual content appearance of the original image by compensating for the difference measure in the first intermediate image.

5. The method of claim 4, wherein the GAN model generates an image transformation matrix based on the training images, and
wherein the GAN model determines the first intermediate image based on the image transformation matrix.

6. The method of claim 1, wherein determining, by the electronic device, the compensating color tone for the original image comprises:
performing, by the electronic device, a pixel difference calculation of a color tone of the original image and a color tone of the virtual content appearance;
generating, by the electronic device, a color compensation matrix for each of a red (R) channel, a green (G) channel, and a blue (B) channel based on the pixel difference calculation of the color tone of the original image and the color tone of the virtual content appearance; and
determining, by the electronic device, the compensating color tone for the original image based on the color compensation matrix,
wherein the compensating color tone for the original image allows a user to view the original image in an original color tone in the current viewing condition.

7. The method of claim 1, wherein modifying, by the electronic device, the original image comprises:
determining, by the electronic device, a plurality of pixels in the original image that are impacted by the ambient light based on the virtual content appearance;
applying, by the electronic device, the compensating color tone for the original image to each of the plurality of pixels in the original image; and
modifying, by the electronic device, a color tone of content in the original image based on the compensating color tone for the original image.

8. The method of claim 1, further comprising:
obtaining, by the electronic device, an illuminance factor of viewing conditions of the original image;
generating, by the electronic device, a color compensated original image for the current viewing condition using a second AI model; and
displaying, by the electronic device, the color compensated original image for the current viewing condition.

9. The method of claim 8, wherein the second AI model is trained based on a plurality of modified original images.

10. The method of claim 8, wherein generating, by the electronic device, the color compensated original image comprises:
concatenating, by the electronic device, the illuminance factor of the viewing conditions and the original image;
determining, by the electronic device, a second intermediate image based the concatenated illuminance factor and the original image as inputs to a generative adversarial network (GAN) model;
determining, by the electronic device, a difference measure between the second intermediate image and training images, wherein the training images comprise a plurality of versions of the plurality of modified original images; and
generating, by the electronic device, the color compensated original image for the current viewing condition using the second AI model.

11. The method of claim 1, wherein the characteristics of the display of the electronic device comprise at least one of:
a peak brightness of the display of the electronic device,
a color temperature of the display,
a color temperature of the original image,
a luminance of the original image, and
a color space of the original image.

12. The method of claim 1, wherein the ambient light comprises a luminance of the ambient light and a correlated color temperature of the ambient light.

13. The method of claim 1, wherein the virtual content appearance of the original image comprises a presentation of contents of the original image in the current viewing condition of the ambient light.

14. An electronic device for digital image enhancement on a display of the electronic device, comprising:
a memory; and
an image enhancement controller coupled to the memory, and configured to:
receive an original image;
sense an ambient light;
generate a virtual content appearance of the original image based on the ambient light and characteristics of the display of the electronic device;
determine a compensating color tone for the original image based on the virtual content appearance;
modify the original image based on the compensating color tone for the original image; and
display the modified original image for a current viewing condition.

15. The electronic device of claim 14, wherein the image enhancement controller is configured to generate the virtual content appearance of the original image by:
determining an illuminance factor of viewing conditions based on content of the original image, the ambient light and the characteristics of the display of the electronic device;
estimating an appearance of a color tone of the content in the original image based on the illuminance factor of the viewing conditions; and
generating the virtual content appearance of the original image based on the estimated appearance of a color tone of the content in the original image using a first artificial intelligence (AI) model.

16. The electronic device of claim 15, wherein the image enhancement controller is configured to determine the illuminance factor of the viewing conditions by:
determining a tri-stimulus value of a virtual illuminant of the viewing conditions based on the original image, ambient light data and the characteristics of the display of the electronic device;
determining a chromaticity co-ordinates for the virtual illuminant of the viewing conditions based on the determined tri-stimulus value;
determining a luminance of the virtual illuminant based on a coordinate of the determined tri-stimulus value; and
determining the illuminance factor of the viewing conditions based on the tri-stimulus value and the chromaticity co-ordinates for the virtual illuminant of the viewing conditions.

17. The electronic device of claim 15, wherein the image enhancement controller is configured to generate the virtual content appearance of the original image by:
concatenating the illuminance factor of the viewing conditions and the original image;
determining a first intermediate image based on the concatenated illuminance factor and the original image as inputs to a generative adversarial network (GAN) model;
determining a difference measure between the first intermediate image and training images, wherein the training images comprise a plurality of versions of the original image captured using a plurality of expected ambient light conditions; and
determining the virtual content appearance of the original image by compensating for the difference measure in the first intermediate image.

18. The electronic device of claim 17, wherein the GAN model generates an image transformation matrix based on the training images, and
wherein the GAN model determines the first intermediate image based on the image transformation matrix.

19. The electronic device of claim 14, wherein the image enhancement controller is configured to determine the compensating color tone for the original image by:
performing a pixel difference calculation of a color tone of the original image and a color tone of the virtual content appearance;
generating a color compensation matrix for each of a red (R) channel, a green (G) channel, and a blue (B) channel based on the pixel difference calculation of the color tone of the original image and the color tone of the virtual content appearance; and
determining the compensating color tone for the original image based on the color compensation matrix,
wherein the compensating color tone for the original image allows a user to view the original image in an original color tone in the current viewing condition.

20. The electronic device of claim 14, wherein the image enhancement controller is configured to modify the original image by:
determining a plurality of pixels in the original image that are impacted by the ambient light based on the virtual content appearance;
applying the compensating color tone for the original image to each of the plurality of pixels in the original image; and
modifying a color tone of content in the original image based on the compensating color tone for the original image.
